(19) United States
(12) Patent Application Publication
(10) Pub. No.: US 2019/0182668 A1
(43) Pub. Date: Jun. 13, 2019

(54) INFORMATION PROCESSING APPARATUS, METHOD OF CONTROLLING THE SAME, AND PROGRAM

(71) Applicant: CANON KABUSHIKI KAISHA, Tokyo (JP)

(72) Inventor: Akari Yasukawa, Kashiwa-shi (JP)

(21) Appl. No.: 16/310,161

(22) PCT Filed: Aug. 22, 2017
(86) PCT No.: PCT/JP2017/029908

§ 371 Date: Dec. 14, 2018

(30) Foreign Application Priority Data
Aug. 24, 2016 (JP) 2016-164063

(51) Int. Cl. H04W 12/06; H04W 48/16; H04L 29/06; H04W 12/00

(52) U.S. Cl. CPC H04W 12/06; H04W 48/16; H04W 88/06; H04W 12/004; H04L 63/083

(57) ABSTRACT

An information processing apparatus has a wireless interface configured to operate in a first mode (an AP mode) that causes the information processing apparatus to operate as an access point and a second mode (an infrastructure mode) that causes the information processing apparatus to operate as a wireless terminal. Also, when, upon activation, the information processing apparatus activates the wireless interface in the second mode and then accepts a predetermined user operation, it switches the wireless interface to the first mode. Furthermore, provision of a wireless LAN setting service by which it is possible to cause the information processing apparatus to connect to an arbitrary network is started.

### TECHNICAL FIELD

The present invention relates to an information processing apparatus for which network setting is performed via a mobile terminal, a method of controlling the same, and a program.

### BACKGROUND ART

Conventionally, there are known systems in which an information processing apparatus and mobile terminal, which are equipped with wireless interfaces, are connected to a network through a wireless access point, the information processing apparatus is operated from the mobile terminal, and information of the information processing apparatus is obtained. A method of, in such a system, when newly connecting an information processing apparatus to a network, using a mobile terminal to set information of a wireless access point to the information processing apparatus in order to simply perform wireless LAN setting has been proposed (for example, PTL 1 and PTL 2).

In PTL 1, a mobile terminal and an information processing apparatus are connected by a wired interface, and the mobile terminal transmits, to the information processing apparatus, network setting information (SSID or key information) for connecting to a wireless access point. The information processing apparatus can complete the joining of the network by accessing the wireless access point in accordance with the obtained network setting information. The mobile terminal and the information processing apparatus communicate via the wireless LAN after the information processing apparatus completes the joining of the network, and a user, by operating the mobile terminal, can control the information processing apparatus and obtain information. Also, in PTL 2, an information processing apparatus and a mobile terminal connect by wireless communication, and network setting information for connecting to a wireless access point is transmitted from the mobile terminal to the information processing apparatus.

However, there is a problem as is recited below in the foregoing conventional technique. However, in the conventional technique described above, a state in which it is continuously possible to perform an operation for causing the information processing apparatus to connect to an arbitrary network from a terminal apparatus (external apparatus) such as a mobile terminal or the like is entered. Accordingly, there is a problem in that there is the possibility that by a third party operating the information processing apparatus from an arbitrary terminal apparatus, the information processing apparatus will be connected to a network against the wishes of the administrator, or the like.

For example, in an information processing apparatus such as a multifunction peripheral used in an office, it is desirable that authorization to use each function of the information processing apparatus and authorization to change settings of the information processing apparatus including network settings be managed appropriately. In such an environment, there is the possibility that appropriate management of the information processing apparatus will cease to be possible when, as with the foregoing conventional technique, a state in which it is possible to cause connection to an arbitrary network by operation from a terminal apparatus continues at all times.

### CITATION LIST

### Patent Literature

PTL 1: Japanese Patent Laid-Open No. 2010-98765

PTL 2: Japanese Patent Laid-Open No. 2013-153533

### SUMMARY OF INVENTION

The present invention enables realization of a mechanism that provides a service for connecting an information processing apparatus to an arbitrary network by operating an external apparatus, and by which management regarding connection to the network that an administrator intends can be performed easily.

One aspect of the present invention provides an information processing apparatus comprising: a wireless interface configured to operate in a first mode for causing the information processing apparatus to operate as an access point, and a second mode for causing the information processing apparatus to operate as a wireless terminal; activation means for activating the wireless interface in the second mode upon activation of the information processing apparatus; and control means for providing a service by which it is possible to cause the information processing apparatus to connect to any network by switching the wireless interface to the first mode when a predetermined user operation is accepted after the wireless interface is activated in the second mode by the activation means.

Another aspect of the present invention provides a method of controlling an information processing apparatus comprising a wireless interface configured to operate in a first mode for causing the information processing apparatus to operate as an access point, and a second mode for causing the information processing apparatus to operate as a wireless terminal, the method comprising: activating the wireless interface in the second mode upon activation of the information processing apparatus; and providing a service by which it is possible to cause the information processing apparatus to connect to any network by switching the wireless interface to the first mode when a predetermined user operation is accepted after the wireless interface is activated in the second mode.

Still another aspect of the present invention provides a program for causing a computer to execute a method of controlling an information processing apparatus comprising a wireless interface configured to operate in a first mode for causing the information processing apparatus to operate as an access point, and a second mode for causing the information processing apparatus to operate as a wireless terminal, the method comprising: activating the wireless interface in the second mode upon activation of the information processing apparatus; and providing a service by which it is possible to cause the information processing apparatus to connect to any network by switching the wireless interface to the first mode when a predetermined user operation is accepted after the wireless interface is activated in the second mode.

Further features of the present invention will be apparent from the following description of exemplary embodiments with reference to the attached drawings.

### BRIEF DESCRIPTION OF DRAWINGS

FIG. 1 is a simplified view illustrating an example of a configuration of a system according to an embodiment.

FIG. 2 is a view illustrating an example of a hardware configuration according to an embodiment.

FIG. 3 is a view illustrating an example of software architecture according to an embodiment.

FIG. 4A is a flowchart for describing basic operation according to an embodiment.

FIG. 4B is a flowchart for describing basic operation according to an embodiment.

FIG. 5A is a view illustrating examples of screens of a printer 101 according to an embodiment.

FIG. 5B is a view illustrating examples of screens of a printer 101 according to an embodiment.

FIG. 5C is a view illustrating examples of screens of a printer 101 according to an embodiment.

FIG. 6A is a flowchart for describing basic operation according to an embodiment.

FIG. 6B is a flowchart for describing basic operation according to an embodiment.

FIG. 7 is a view illustrating an example of a screen of the printer 101 according to an embodiment.

### DESCRIPTION OF EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<System Configuration>

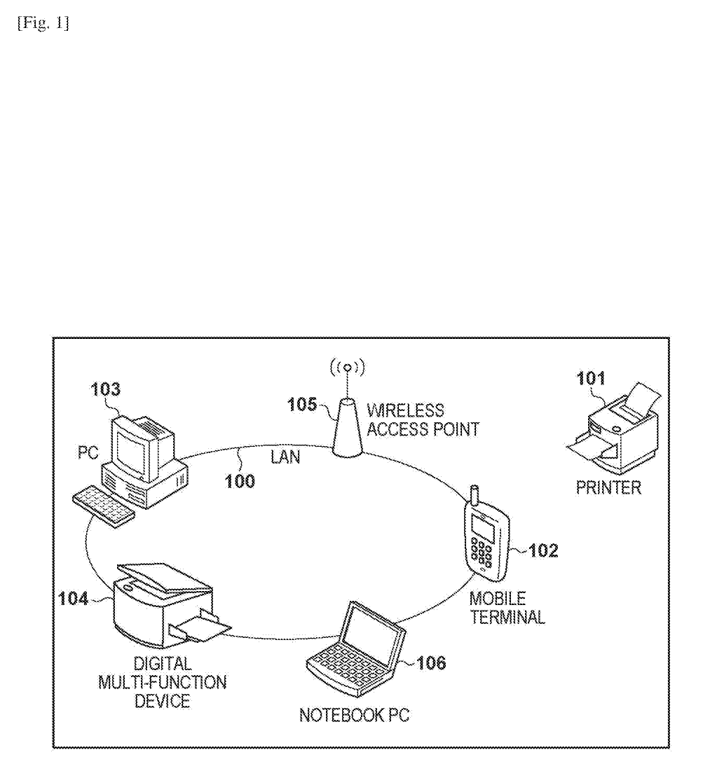

Below, description will be given for a first embodiment of the present invention. First, with reference to FIG. 1, an example of a configuration of a system according to the present embodiment is described.

The system according to the present embodiment is configured to include a plurality of devices and a mobile terminal which are connected to a network. For example, in the system illustrated in FIG. 1, a PC 103, a digital multi-function device 104, a notebook PC 106, a printer 101 which is an information processing apparatus, and a mobile terminal 102 which is an external apparatus are included. In the present system, the plurality of devices are connected to a LAN 100 via a single wireless access point 105, and can perform two-way communication with the other devices connected to the LAN 100. Note that the system illustrated in FIG. 1 is only one example, and is not intended to limit the types or numbers of devices included in the system of the present invention. For example, the system may be configured to include other types of devices.

Here, a state in which the printer 101 of FIG. 1 is not connected to the LAN 100 since network settings for connecting to the wireless access point 105 have not been performed is illustrated. The mobile terminal 102, via the wireless access point 105, can connect to the LAN 100 and perform two-way communication with the other devices that are connected to the LAN 100, and it is possible to operate and perform status confirmation of each device from the mobile terminal 102. By virtue of the present embodiment, causing the printer 101 to connect to the LAN 100 via the wireless access point 105 by operating the mobile terminal 102 is enabled. Accordingly, below, configuration and operation of the printer 101 and the mobile terminal 102 are primarily described.

<Hardware Configuration>

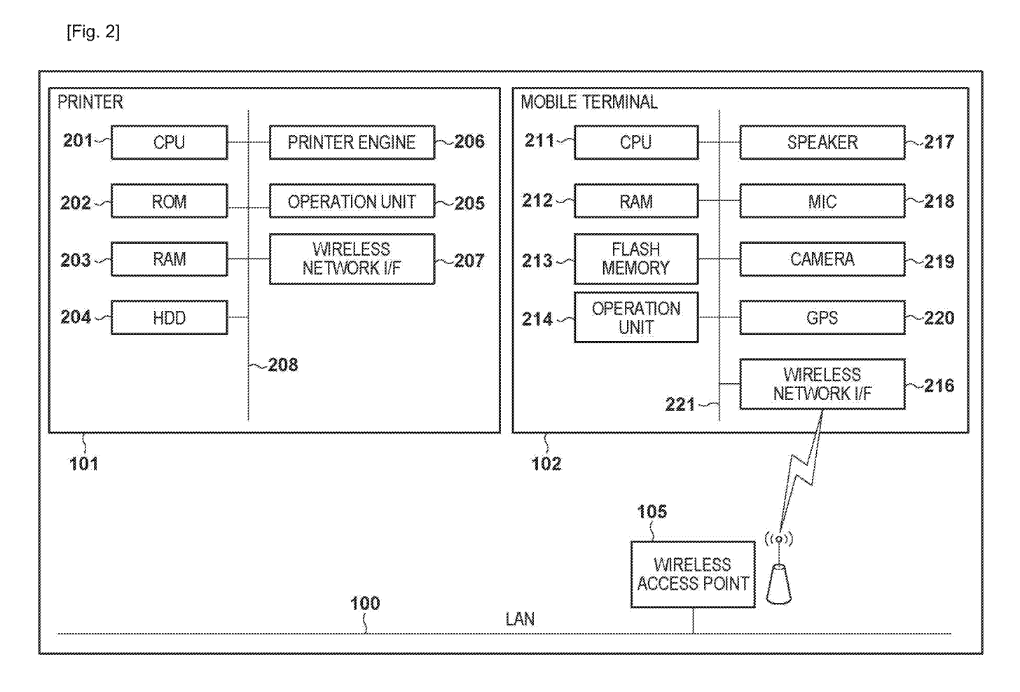

Next, with reference to FIG. 2, an example of a hardware configuration of the devices according to the present embodiment is described. First, a hardware configuration of the printer 101 is described. The printer 101 comprises a CPU 201, a ROM 202, a RAM 203, an HDD 204, an operation unit 205, a printer engine 206, and a wireless network I/F 207. The components are connected via a bus 208, and can exchange data with each other.

The CPU 201 comprehensively controls operations of the printer 101 on the whole. The CPU 201 performs various control such as print control by reading a control program stored in the ROM 202. The RAM 203 is a volatile memory that the CPU 201 uses, for example as a work area for executing various programs. The HDD 204 stores image data, various programs, or the like. The operation unit 205 is equipped with a display that operates as a touch panel and can be operated by a finger of the user. The printer engine 206 prints, on a sheet, image data transferred via the bus 208.

The wireless network interface 207 is an NIC (Network Interface Card) that supports wireless networking and can connect to the wireless access point 105 and perform network communication. The wireless network I/F 207 has a function for connecting to a wireless LAN by a method compatible with an IEEE 802.11b/g/n standard, for example. Also, the wireless network I/F 207, according to an instruction from the CPU 201, can operate in a software access point mode (hereinafter referred to as an access point mode) and an infrastructure mode (hereinafter referred to as an infrastructure mode). In the access point mode (first mode), it is possible for the printer 101 itself to operate as a wireless access point, and communicate with other wireless LAN equipped devices (for example, the mobile terminal 102). In the infrastructure mode (second mode), the printer 101 can operate as a wireless terminal, and connect to a network by connecting to a wireless access point such as the wireless access point 105. Note that it is possible for the access point mode and the infrastructure mode to operate simultaneously rather than exclusively.

Next, a hardware configuration of the mobile terminal 102 is described. The mobile terminal 102 comprises a CPU 211, a RAM 212, a flash memory 213, an operation unit 214, a wireless network I/F 216, a speaker 217, a mic 218, a camera 219, and a GPS 220. Each component is connected via a bus 221, and can exchange data with each other.

The CPU 211 comprehensively controls operations of the mobile terminal on the whole. The RAM 212 is a volatile memory that the CPU 211 uses as a work area for executing various programs or the like. The flash memory 213 is a non-volatile memory that stores various programs or data. The operation unit 214 is equipped with a display that operates as a touch panel that can be operated by a finger of a user.

The wireless network interface 216 is an NIC that is supports wireless networking and can connect to the wireless access point 105 and perform network communication. The speaker 217 is an apparatus that converts an electronic audio signal into sound that is outputted. The ride 218 detects sound and converts it into an electronic signal. The camera 219 captures a still image or a moving image, and converts it into electronic data. The GPS 220 is a Global Positioning System receiver.

<Software Architecture>

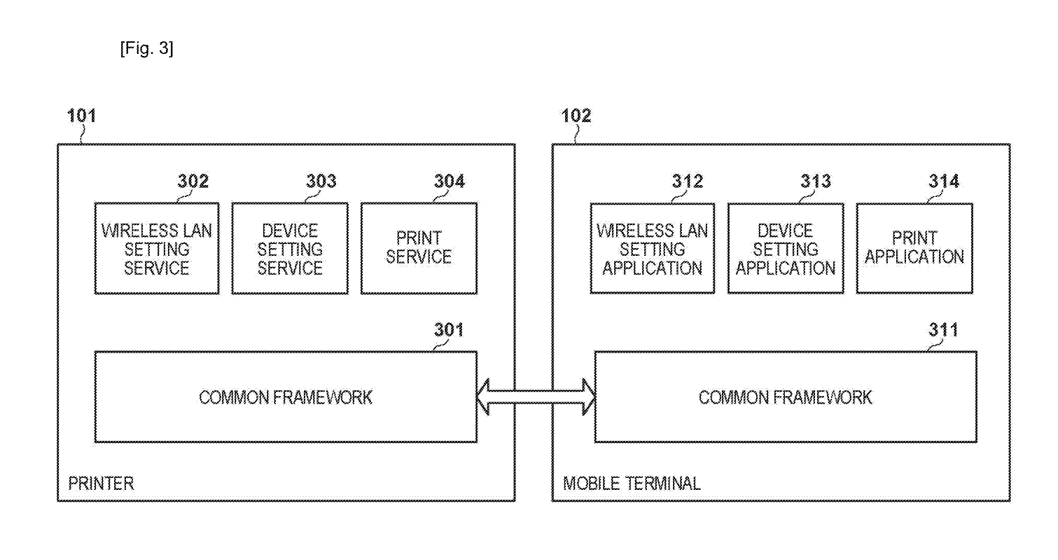

Next, with reference to FIG. 3, a software architecture according to the present embodiment is described. The printer 101 and the mobile terminal 102 operate on a common framework that defines the communication protocol for communication via the wireless network I/F 207, and perform two-way peer-to-peer communication based on the framework specification. The common framework may be independently developed by a device manufacturer or may be a framework that is established in a standard and independent of the manufacturer. AllJoyn (registered trademark) is an example of a standard that is employed.

Applications 312 to 314 which operate based on a common framework 311 are installed in the mobile terminal 102, and it is possible to operate each device through these applications. In the example of FIG. 3, the wireless LAN setting application 312, the device setting application 313, and the printing application 314 are installed in the mobile terminal 102. While a plurality of applications are installed here, these applications may be configured as a single application.

The printer 101 is equipped with a common framework 301, and services such as a wireless LAN setting service 302, a print service 304 for performing printing, and a device setting service 303 for performing various settings of the printer 101 operate on the common framework. The printer 101 advertises its own services on the network via the common framework 301.

By this, it is possible for an application of the mobile terminal 102 to search for what kind of services the printer 101 has (discovery). For example, when the printing application 314 of the mobile terminal 102 activates, the printing application 314 starts a search for a print service on the network. The printing application 314, upon detecting the print service 304 of the printer 101, can perform communication with the printer 101 via the common framework 311, and thereby the print service 304 of the printer 101 can be used from the mobile terminal 102. Note that processing of each of the services 302 to 304 and the common framework 301 of the printer 101 is executed by the CPU 201, and the processing of each of the applications 312 to 314 and the common framework 311 of the mobile terminal 102 is executed by the CPU 211. In the present embodiment, it is described that the common framework 301 operates via the wireless network I/F 207, but it may operate by another communication method such as NFC, Bluetooth (registered trademark), or the like.

Next, the wireless LAN setting service 302 equipped in the printer 101 is described in more detail. When the wireless LAN setting service 302 is used, it becomes possible to perform a wireless LAN setting of the printer 101 via the network, and it is possible to cause the printer 101 to join a wireless LAN thereby. This kind of service is sometimes called an Onboarding service.

The printer 101 accepts an access point search request command and a wireless LAN setting command from the mobile terminal 102 by using the wireless LAN setting service 302. The access point search request command is a command for requesting a scan for an access point in the vicinity of the printer 101, and obtaining a result thereof. The wireless LAN setting command is a command for performing wireless LAN settings of the printer 101. In the present embodiment is described a method of using the wireless LAN setting service 302 to cause the printer 101 to join the LAN 100 when it is in a state in which it is not yet connected to the wireless access point 105.

<Processing Procedure>

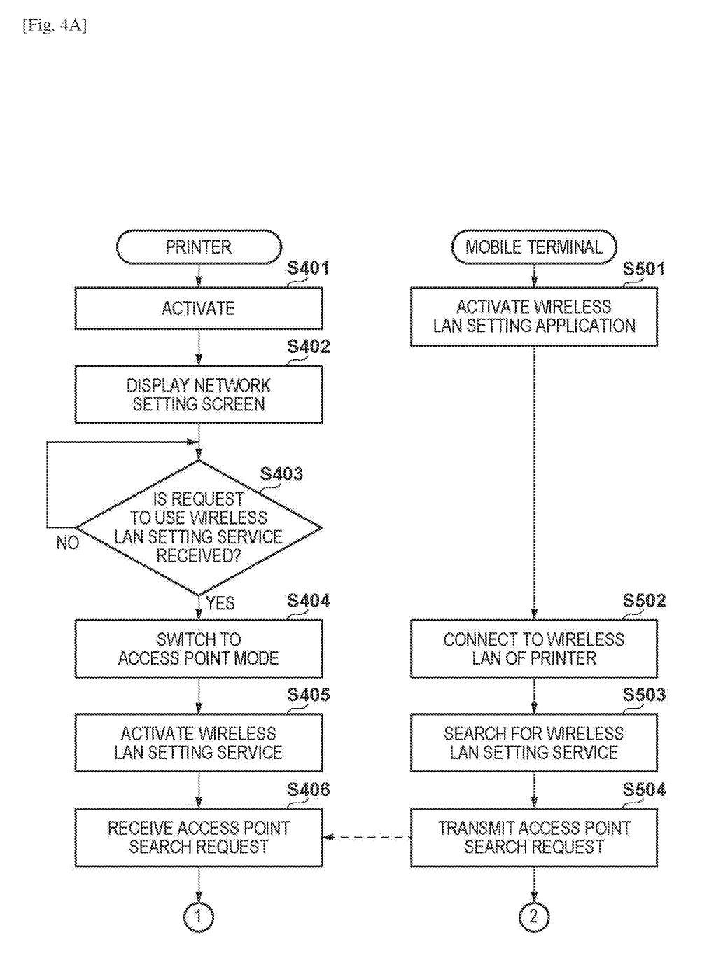

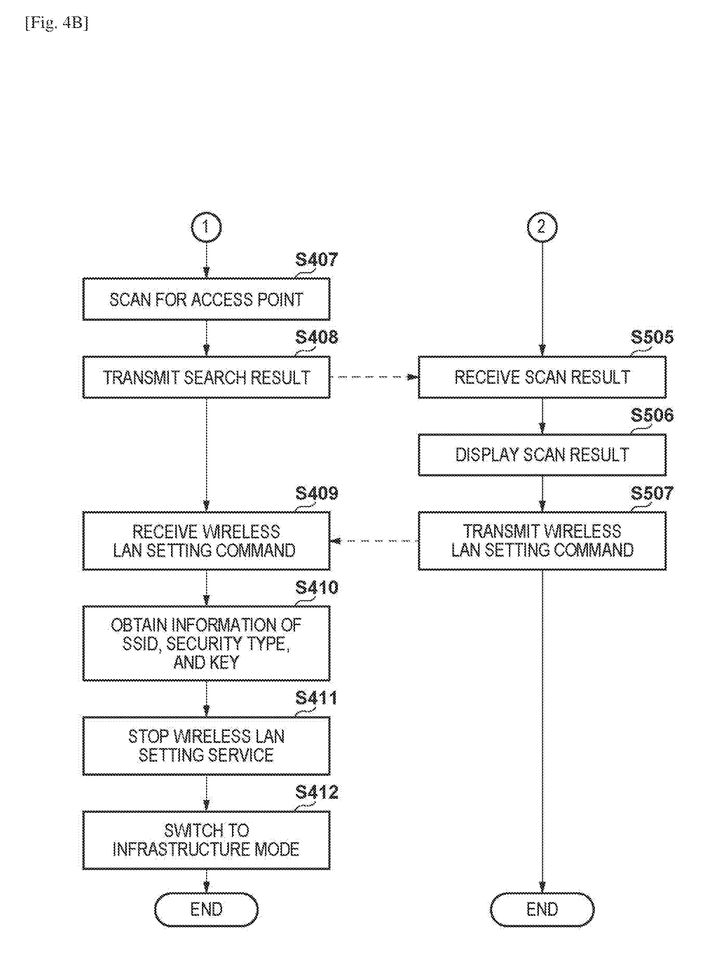

Next, with reference to FIGS. 4A and 4B, description is given regarding a processing procedure in the present embodiment for connecting the printer 101 to the wireless access point 105. The processing described below is realized for the printer 101 by the CPU 201 reading a control program stored in the ROM 202 or the HDD 204 into the RAM 203, and executing it. Meanwhile, the processing is realized for the mobile terminal 102 by the CPU 211 reading a control program stored in the flash memory 213 into the RAM 212, and executing it.

Operation of the printer 101 is described. In step S401, the CPU 201 activates the wireless network I/F 207 in the infrastructure mode in conjunction with the power of the printer 101 being turned ON. In this way, the printer 101 according to the present embodiment activates in the infrastructure mode and not in the AP mode when it activates. However, because setting for connecting to the wireless access point 105 has not been performed at this point, the printer 101 cannot perform communication with the wireless access point 105.

Next, in step S402, the CPU 201, when a predetermined user operation is received via the operation unit 205, displays a network setting screen 500 to the operation unit 205. Here, the printer 101, prior to displaying the network setting screen 500, may perform user authentication by accepting input of a user name and a password in the operation unit 205. By this, it is possible to restrict so that the network setting screen 500 is only displayed to a user having a network setting authority.

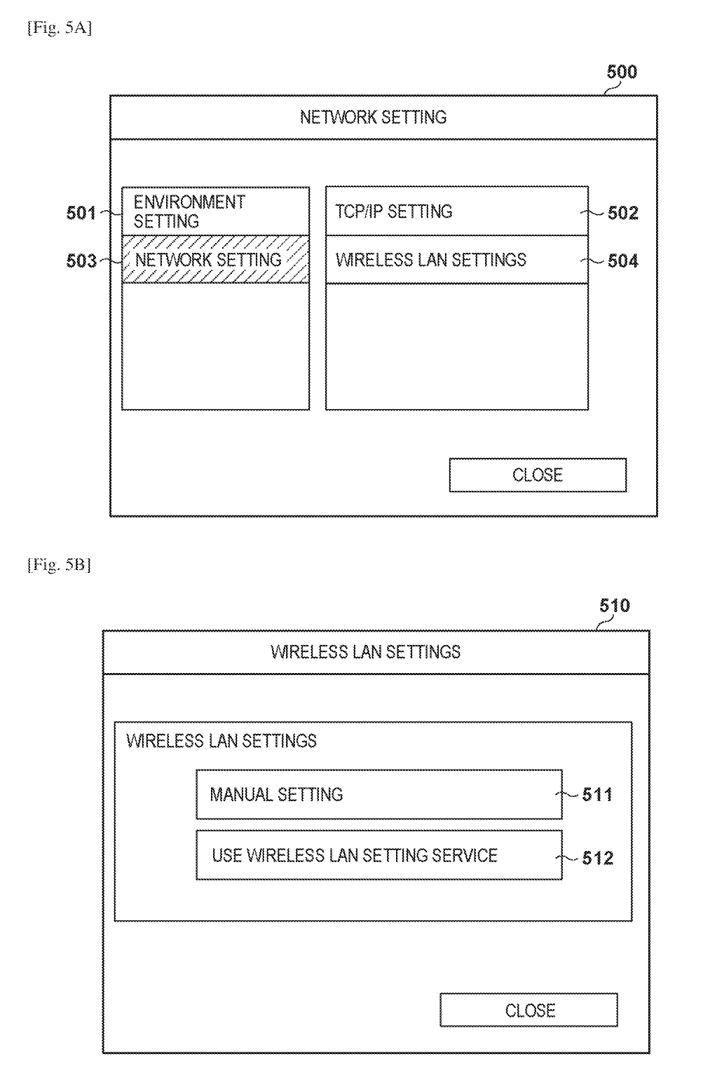

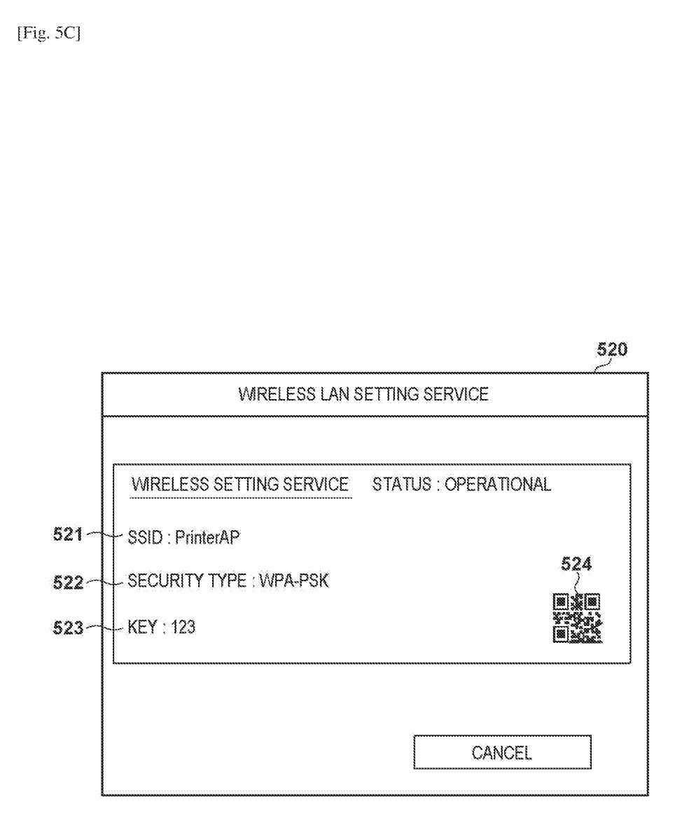

In the network setting screen 500 illustrated in FIGS. 5A to 5C, buttons for transitioning to various setting screens are displayed, and, for example, an environment setting 501, a TCP/IP setting 502, a network setting 503, and a wireless LAN setting 504 are displayed. In the present embodiment, it is assumed the wireless LAN setting 504 is selected, and a wireless LAN setting screen 510 is transitioned to. On the wireless LAN setting screen 510, “manual setting” 511 and “use wireless LAN setting service” 512 are displayed selectably as wireless LAN settings.

The description of FIGS. 4A and 4B is returned to. In step S403, the CPU 201 determines whether or not a request to use the wireless LAN setting service is accepted in the wireless LAN setting screen 510 via the operation unit 205. When this request is accepted, the processing proceeds to step S404, the CPU 201 switches the wireless network I/F 207 to the access point mode, and the processing proceeds to step S405. In the present embodiment, at this time, as authentication information, the SSID (Service Set Identifier) is fixed to be “PrinterAP” and the network KEY is fixed to be “123”. Furthermore, the CPU 201 displays on the operation unit 205 a wireless LAN setting service screen 520 which includes the foregoing authentication information.

As illustrated in FIG. 5C, in the wireless LAN setting service screen 520, an SSID (PrinterAP) 521 as an identifier, a security type (“WPA-PSK”) 522, and KEY (“123”) 523 as a password are displayed. Furthermore, on the wireless LAN setting service screen 520, a barcode image 524 including information of the SSID and the KEY is displayed. By this, configuration is such that it is possible for the mobile terminal 102 to obtain the access point information of the printer 101 easily by using the camera 219. Here, the SSID and the KEY may be predetermined information, information that a user sets in relation to the printer 101 in advance, or information that the printer 101 automatically generated (dynamically generated) randomly. By making the SSID and the KEY variable, only a user that knows them can connect to the printer 101, and it is possible to prevent an undesired user from illicitly connecting to the printer 101.

The description of FIGS. 4A and 4B is returned to. In step S405, the CPU 201 starts the wireless LAN setting service 302, and advertises the service on the network using the common framework 301. By advertising the wireless LAN setting service 302, it becomes possible to reference the wireless LAN setting service 302 as a service of the printer 101 from the mobile terminal 102.

Meanwhile, in the mobile terminal 102, in step S501, the CPU 211 activates the wireless LAN setting application 312 based on an instruction from the user. Additionally, the CPU 211, using the wireless network I/F 216, searches for an access point in the vicinity, displays the result on the operation unit 214, and thereby allows the user to select the access point to connect to. Here, it is assumed that “PrinterAP” which is the SSID of the printer 101 is selected from the results of a search in order to connect to the printer 101. When the SSID (“PrinterAP”) of the printer 101 is selected, the mobile terminal 102 prompts the user to input the corresponding KEY.

When input of the KEY (here, “123”) is accepted from the user, the processing proceeds to step S502, and the CPU 211 connects by peer-to-peer by the wireless network to the printer 101 using the inputted SSID and KEY. Here, configuration may be such that the information of the SSID and KEY are not inputted from the user, but rather are obtained by reading the two-dimensional barcode image 524 displayed on the operation unit 205 of the printer 101 by using the camera 219 of the mobile terminal 102 as previously described.

Next, in step S503, the CPU 211 searches for a service of the printer 101 and obtains information of a service (the wireless LAN setting service here) that the printer 101 provides. Here, services being advertised by the printer 101 are searched. When the CPU 211 confirms as the result of the service search that the printer 101 has the wireless LAN setting service 302, the CPU 211 starts a communication session with the printer 101 in order to use the service. Then, in step S504, the CPU 211 transmits the above described access point search request command to the printer 101.

Meanwhile, in the printer 101, the CPU 201, in step S406, receives the access point search request command from the mobile terminal 102 via the wireless network I/F 207. Then, in step S407, the CPU 201 scans (searches) for beacon information transmitted from an access point that is positioned in the vicinity of the printer 101 using the wireless network I/F 207. Based on the results of the scan (search results), the CPU 201 obtains the SSIDs and security types of the access points that can be connected to. The security type illustrates a wireless communication encryption method and authentication method. Then, in step S408, the CPU 201 transmits to the mobile terminal 102 a list of access points found as the result of the search.

Meanwhile, in the mobile terminal 102, in step S505, the CPU 211 receives a list of access points from the printer 101, and displays the results on the operation unit 214 in step S506. Here, the user operating the mobile terminal 102 selects an access point that can be connected to from out of the list. In the present embodiment, the SSID of the wireless access point 105 is selected. Also, in the case where encryption is set for the selected access point, it is possible use the access point for which encryption is performed by further inputting the network KEY. In step S507, the CPU 211 transmits the wireless LAN setting command to the printer 101 when input is accepted from the user. Network setting information such as information of the access point SSID, KEY, and security type are included in the wireless LAN setting command. Note that the foregoing network setting information is information for accessing the wireless access point 105, for example, and is different to authentication information for accessing the printer 101 described above (that is, information displayed on the wireless LAN setting service screen 520).

Meanwhile, in the printer 101, when the CPU 201, in step S409, receives from the mobile terminal 102 the wireless LAN setting command, the CPU 201, in step S410, obtains network setting information included in the command, specifically, information of the SSID, the KEY, and the security type. When obtainment succeeds, the CPU 201, in step S411, stops the wireless LAN setting service. Then, in step S412, the CPU 201 switches the wireless network I/F 207 into the infrastructure mode, and in accordance with the access point information obtained in step S410, connects to the wireless access point 105, and ends the processing.

When the connection with the wireless access point 105 succeeds, thereafter, communication with the mobile terminal 102 is performed via the wireless LAN 100, and it becomes possible to perform operations of the printer 101 such as settings and printing through an application installed in the mobile terminal 102. Note that the printer 101, by stopping the wireless LAN setting service in step S411 also stops advertising of the wireless LAN setting service, and thereafter even if a wireless LAN setting service command is received from the mobile terminal 102, it discards the received data without performing the corresponding processing. Also, in the present embodiment, prior to switching to the infrastructure mode in step S412, the wireless LAN setting service is stopped in step S411, but the timing of the stopping of the service is not limited to this.

As described above, the information processing apparatus according to the present embodiment has a wireless interface capable of operating in a first mode (the AP mode) for causing the information processing apparatus to operate as an access point, and a second mode (the infrastructure mode) for causing the information processing apparatus to operate as a wireless terminal. Also, when, upon activation, the information processing apparatus activates the wireless interface in the second mode and then accepts a predetermined user operation, a switch to the first mode is set, and when the switch is set, the wireless interface is switched to the first mode. Furthermore, provision of a wireless LAN setting service by which it is possible to cause the information processing apparatus to connect to an arbitrary network is started. Accordingly, by virtue of the present embodiment, in a case where a wireless LAN setting of a device is performed via a network, it is possible to perform activation of a wireless LAN setting service only at a time when a request from a user is received. Furthermore, it is possible to prevent a wireless LAN setting being rewritten illicitly via a network. Specifically, it is possible to provide a service for connecting an information processing apparatus to an arbitrary network by operating an external apparatus, and also provide a mechanism by which it is possible to easily manage connection to the network as desired by an administrator.

### Second Embodiment

Below, description will be given for a second embodiment of the present invention. In the present embodiment, description is given of a method in which in step S407 of FIG. 4B, a wireless LAN setting command including access point information is received, but communication on a common framework is secured in order to transfer access point information more securely.

In the common frameworks 301 and 311 illustrated in FIG. 3, a function for authenticating a communication partner device and a data encryption function are included to prevent tapping of data that is transmitted on the network and communication with an illicit device. The method of authentication may be a pre-shared key method or a certificate method. In the pre-shared key method, a key shared between the printer 101 and the mobile terminal 102 is held in advance, and by confirming whether they are holding the same key when starting a communication session, they mutually authenticate. In the certificate method, the devices exchange their certificates with each other when starting a communication session, and perform mutual authentication by confirming the information included in the certificates. When the mutual authentication succeeds, a key (session key) for data encryption is shared by a key exchange algorithm such as Diffie-Hellman, and thereafter, encryption of communication data is performed using the session key. The printer 101 and the mobile terminal 102 hold certificate and pre-shared key information respectively in the HDD 204 and the flash memory 213.

<Processing Procedure>

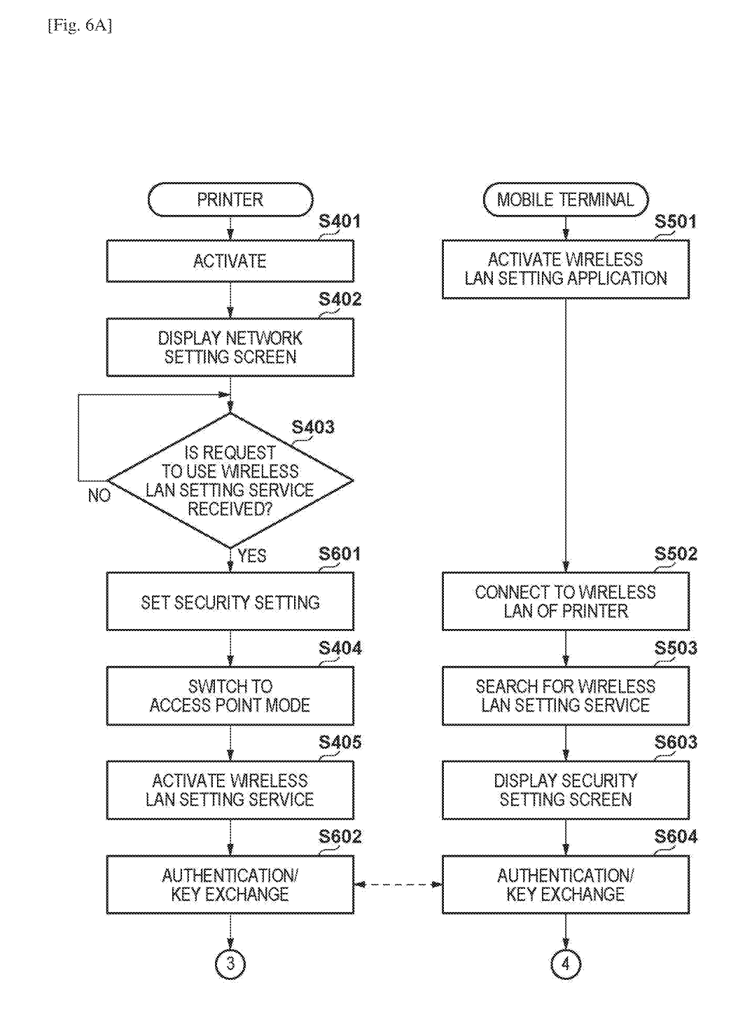

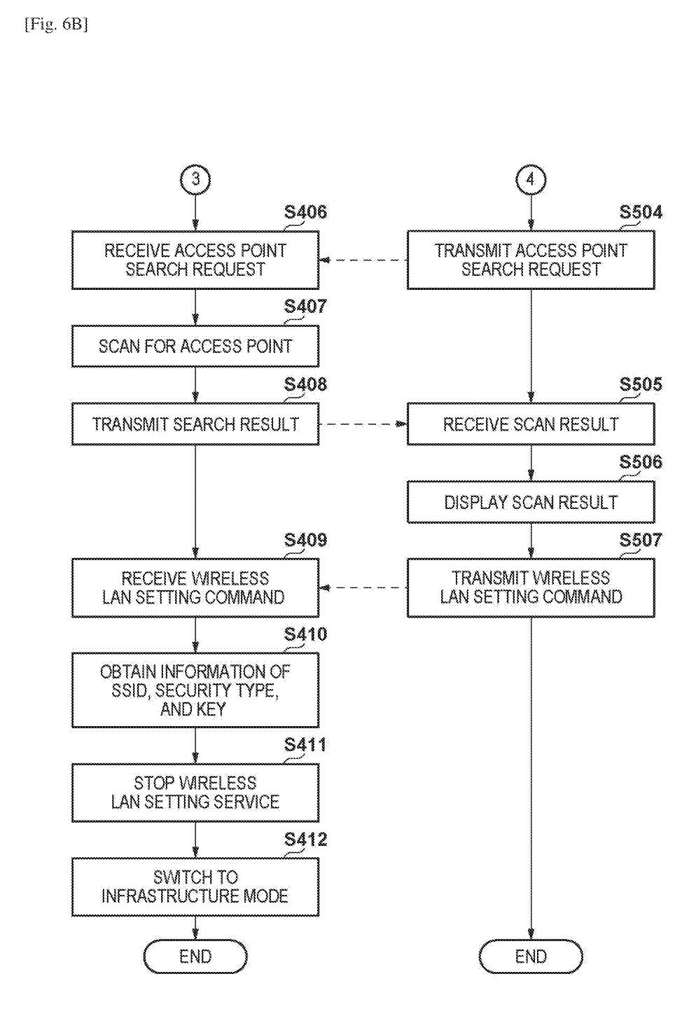

Next, with reference to FIGS. 6A and 6B, description is given regarding a processing procedure in the present embodiment for connecting the printer 101 to the wireless access point 105. Here, explanation is given of a method for implementing mutual authentication using the pre-shared key method described previously. The processing described below is realized for the printer 101 by the CPU 201 reading a control program stored in the ROM 202 or the HDD 204 into the RAM 203, and executing it. Meanwhile, the processing is realized for the mobile terminal 102 by the CPU 211 reading a control program stored in the flash memory 213 into the RAM 212, and executing it.

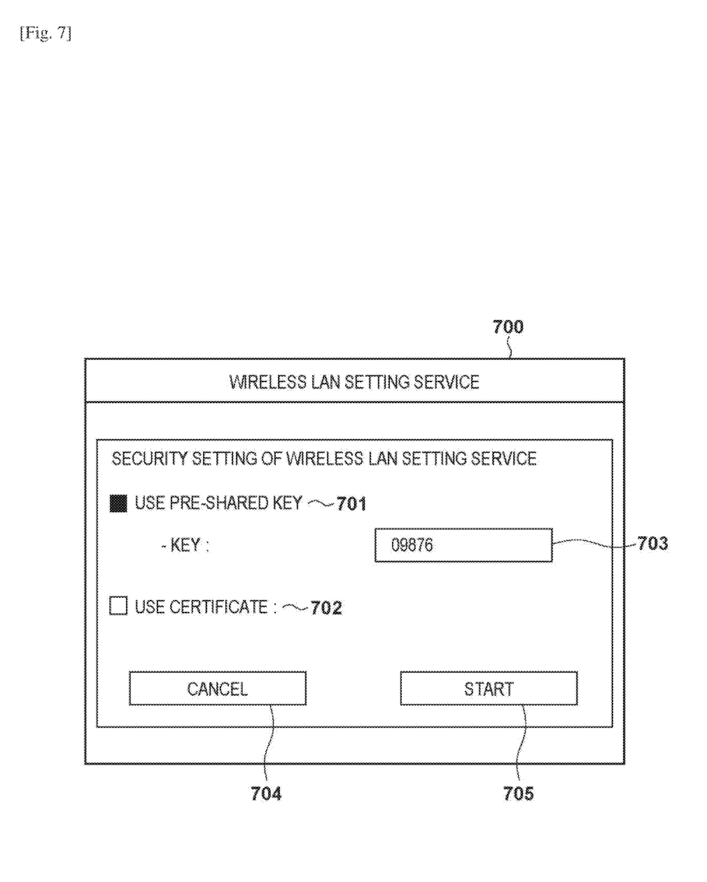

Note that the processing of step S401 through step S403 is the same as in FIG. 4A, and therefore description thereof is omitted. When a request to use the wireless LAN setting service is accepted in step S403, the CPU 201, in step S601, displays on the operation unit 205 a security setting screen 700 for setting a wireless LAN setting service security setting. An example of the screen is illustrated on FIG. 7. As illustrated in FIG. 7, on the security setting screen 700, “use pre-shared key” (701) or “use certificate” (702) are displayed selectably as security settings. Furthermore, in the security setting screen 700, an input area 703 for inputting a pre-shared key that can be inputted in a case where “use pre-shared key” is selected, a cancel button 704, and a start button 705 are included. When the cancel button 704 is operated, the content set in the security setting screen 700 is discarded, and the original screen is returned to. Also, when the start button 705 is operated, the wireless LAN setting service is started with the content set in the security setting screen 700.

The description of FIGS. 6A and 6B is returned to. In the case where “use pre-shared key” is selected, the CPU 201 controls to enable input to the input area 703, and requests input of the pre-shared key. Meanwhile, in the case where “use certificate” is selected, the CPU 201 further displays on the operation unit 205 a screen (not shown) for selecting the certificate to use from out of the certificates stored in the HDD 204, and requests selection of the certificate to use. Here, assume “use pre-shared key” is selected. In FIG. 7, “09876” is set in the input area 703 as the pre-shared key. Furthermore, when the CPU 201 determines that the start button 705 has been pressed, similarly to in FIGS. 4A and 4B, the CPU 201 switches the wireless network I/F 207 to the access point mode, and displays the SSID 521 and the KEY 523 on the operation unit 205. Then, the CPU 201, in step S405, starts the wireless LAN setting service. Here, when the CPU 201 advertises the wireless LAN setting service 302, the CPU 201 includes the security setting information (here the pre-shared key method is used) in the advertisement.

Meanwhile, in the mobile terminal 102, the CPU 211, in step S503, obtains information of a service (the wireless LAN setting service 302 here) that the printer 101 is providing. Here, the CPU 211 also further obtains information of the security setting of the wireless LAN setting service. When the security setting of the printer 101 is confirmed to be enabled, the processing proceeds to step S603, and the CPU 211 displays on the operation unit 214 the security setting input screen. Here, because the printer 101 is set to use the pre-shared key, the CPU 211 prompts input of the pre-shared key on the operation unit 214. Here, “09876” which is the same as what is set in the printer 101 as the pre-shared key is inputted.

After that, in step S604, when the CPU 211 accepts input of the pre-shared key, the CPU 211 requests that the printer 101 start the communication session by using the common framework 301 in order to use the wireless LAN setting service 302 of the printer 101. At that time, the CPU 211 executes authentication and a session key exchange using the pre-shared key inputted in step S603.

Meanwhile, in the printer 101, when the CPU 201, in step S602, accepts the request to start the session from the mobile terminal 102, the CPU 201 executes authentication of the mobile terminal 102 and exchange of session keys by using the pre-shared key set in step S601. Thereafter, the communication data of the mobile terminal 102 and the printer 101 is encrypted by using the session key that was exchanged. Note that, when the CPU 201, in step S602, determines that the authentication of the mobile terminal 102 failed, it rejects the start of the communication session. Meanwhile, when the CPU 201 determines that authentication of the mobile terminal 102 and session key exchange succeeded, the CPU 201 advances the processing to step S406. The processing thereafter, specifically step S406 through step S412 and the processing of step S504 through step S507 is similar to in the flowchart of FIGS. 4A and 4B, and so explanation thereof is omitted.

In the present embodiment, after receiving the request to use the wireless LAN setting service in step S403, security setting of the printer 101 is performed. The timing of the security setting is not limited to this, and input from the user may be accepted as a setting item for network setting in advance, and the inputted setting value may be held in the HDD 204 of the printer 101. Configuration may be taken so that the CPU 201 reads and uses a security setting value set in advance from the HDD 204 in step S405 and in step S602.

As described above, the information processing apparatus according to the present embodiment, when performing network setting, performs security settings for selecting a pre-shared key method or a certificate method. Accordingly, when performing wireless LAN setting of a device via a network, authentication of a communication destination and encryption of communication data becomes possible by performing security setting in advance, and a user can execute a wireless LAN setting of the printer 101 more securely via a network.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-164063 filed on Aug. 24, 2016, which is hereby incorporated by reference herein in its entirety.

1. An information processing apparatus comprising:
a wireless interface configured to operate in a first mode for causing the information processing apparatus to operate as an access point, and a second mode for causing the information processing apparatus to operate as a wireless terminal;
a storage device configured to store an image formation job;
a memory device that stores a set of instructions; and
at least one processor that executes the set of instructions to:
activate the wireless interface in the second mode upon activation of the information processing apparatus; and
provide a service by which it is possible to cause the information processing apparatus to connect to any network by switching the wireless interface to the first mode when a predetermined user operation is accepted after the wireless interface is activated in the second mode.

2. The information processing apparatus according to claim 1, further comprising a display for displaying a network setting screen for accepting a predetermined user operation, wherein
the display, when the wireless interface is switched to the first mode by the at least one processor, displays authentication information for accessing the information processing apparatus.

3. The information processing apparatus according to claim 2, wherein the at least one processor executes instructions in the memory device to:
when an access that uses the authentication information by an external apparatus is accepted, cause the information processing apparatus to connect to a predetermined network in accordance with an instruction from the external apparatus.

4. The image processing apparatus according to claim 3, wherein the at least one processor executes instructions in the memory device to:
when an access that uses the authentication information by an external apparatus is accepted, search for an access point positioned in the vicinity, transmit a search result to the external apparatus, and, when a predetermined access point is selected from the search result by the external apparatus, connect to the selected predetermined access point.

5. The information processing apparatus according to claim 2, wherein the at least one processor executes instructions in the memory device to:
in a case where an access that uses the authentication information is accepted in a state in which the service is not being provided, discard the access.

6. The information processing apparatus according to claim 2, wherein the authentication information includes an identifier that identifies the information processing apparatus and a password.

7. The information processing apparatus according to claim 6, wherein the identifier and the password are predetermined information.

8. The information processing apparatus according to claim 6, wherein the identifier and the password are information accepted from a user.

9. The information processing apparatus according to claim 6, wherein the identifier and the password are information generated dynamically by the at least one processor.

10. The information processing apparatus according to claim 6, wherein the display displays the authentication information which includes information of the identifier and the password in a two-dimensional barcode.

11. The information processing apparatus according to claim 4, wherein the at least one processor executes instructions in the memory device to:
when it connects to the predetermined access point, stop providing the service, and switch the wireless interface to the second mode.

12. The information processing apparatus according to claim 2,
wherein the at least one processor executes instructions in the memory device to:
display a security setting screen for setting security of the service, wherein
a pre-shared key method and a certificate method are displayed selectably in the security setting screen.

13. The information processing apparatus according to claim 12, wherein an input area for a pre-shared key that can be inputted when the pre-shared key method is selected is included in the security setting screen.

14. The information processing apparatus according to claim 12,
wherein the at least one processor executes instructions in the memory device to:
when an access that uses the authentication information from an external apparatus is accepted, exchange with the external apparatus a pre-shared key for the pre-shared key method or a certificate for the certificate method, and authenticate the external apparatus thereby.

15. A method of controlling an information processing apparatus comprising a wireless interface configured to operate in a first mode for causing the information processing apparatus to operate as an access point, and a second mode for causing the information processing apparatus to operate as a wireless terminal, the method comprising:
activating the wireless interface in the second mode upon activation of the information processing apparatus; and
providing a service by which it is possible to cause the information processing apparatus to connect to any network by switching the wireless interface to the first mode when a predetermined user operation is accepted after the wireless interface is activated in the second mode.

16. A non-transitory computer-readable storage medium storing a program for causing a computer to execute a method of controlling an information processing apparatus comprising a wireless interface configured to operate in a first mode for causing the information processing apparatus to operate as an access point, and a second mode for causing the information processing apparatus to operate as a wireless terminal, the method comprising:
activating the wireless interface in the second mode upon activation of the information processing apparatus; and
providing a service by which it is possible to cause the information processing apparatus to connect to any network by switching the wireless interface to the first mode when a predetermined user operation is accepted after the wireless interface is activated in the second mode.
